(19) United States
(12) Patent Application Publication
(10) Pub. No.: US 2017/0108988 A1
(43) Pub. Date: Apr. 20, 2017

(54) METHOD AND APPARATUS FOR RECOGNIZING A TOUCH DRAG GESTURE ON A CURVED SCREEN

(71) Applicant: Hyundai Motor Company, Seoul (KR)

(72) Inventor: Ga Hee KIM, Suwon-si (KR)

(73) Assignee: Hyundai Motor Company, Seoul (KR)

(21) Appl. No.: 15/195,294

(22) Filed: Jun. 28, 2016

(30) Foreign Application Priority Data
Oct. 15, 2015 (KR) 10-2015-0144299

(51) Int. Cl. G06F 3/041; G06F 3/0488; G06F 3/042

(52) U.S. Cl. CPC G06F 3/0418; G06F 3/0421; G06F 3/0412; G06F 3/04883; G06F 2203/04108

(57) ABSTRACT

A method and an apparatus for recognizing a touch drag gesture on a curved screen are provided. A method for recognizing a touch drag gesture on a curved screen may include: dividing the curved screen into a plurality of areas; setting a plurality of threshold values, where each threshold value corresponds to a gesture start direction in the plurality of areas; detecting a gesture start point based on infrared images received from an infrared camera disposed to face the curved screen; determining an area where the gesture start point exists from among the plurality of areas; determining a gesture start direction in the area where the gesture start point exists; selecting a threshold value that corresponds to the gesture start direction in the area where the gesture start point exists from among the plurality of threshold values; calculating a length of a trajectory from the gesture start point to a gesture end point; and recognizing the touch drag gesture based on the trajectory when the length of the trajectory is greater than the selected threshold value.

### CROSS-REFERENCE TO RELATED APPLICATION

The present application claims priority to, and the benefit of, Korean Patent Application No, 10-2015-0144299 filed in the Korean Intellectual Property Office on Oct. 15, 2015, the entire contents of which are incorporated herein by reference.

### BACKGROUND

(a) Field of the Disclosure

The present disclosure relates to a curved display apparatus for a vehicle. More particularly, the present disclosure relates to a method and an apparatus for recognizing a touch drag gesture on a curved screen.

(b) Description of the Related Art

Various electronic devices such as a navigation device, an audio device, and an air conditioner are mounted within a vehicle for a driver's convenience. In addition, various input devices such as a key pad, a jog dial, and a touch screen have been used to control various functions of the electronic devices.

Some of the electronic devices are controlled by a remote control method in order to prevent a driver's eyes from deviating from a road in front of the vehicle. As the remote control method, there is a method for controlling the electronic devices by using a button disposed on a steering wheel or recognizing a user's gesture.

Recently, attempts have been made to apply a touch display apparatus to a cluster or an audio-video-navigation (AVN) system in order to improve an operating feeling of a user and an interior design of a vehicle.

FIG. 7 and FIG. 8 are drawings used for explaining a method for recognizing a touch drag gesture according to the related art.

As shown in FIG. 7, a rear surface projection type of touch display apparatus uses a projector which is disposed in a rear surface of a screen to project an image. In order to recognize a touch gesture of a user, an infrared illuminator and an infrared camera may be used. The infrared illuminator outputs infrared rays to the screen, and the infrared camera captures an infrared image.

The touch display apparatus detects a gesture start point, a gesture end point, and a trajectory from the gesture start point to the gesture end point based on the infrared image. In order to eliminate misrecognition, the touch display apparatus recognizes a touch drag gesture of a user by using the trajectory only when a length of the trajectory is greater than a threshold value. Since a step does not exist at a flat screen 10A, gesture recognition performance is the same at any position even though the threshold value is fixed.

However, as shown in FIG. 8, since a step exists at a curved screen 10B, the gesture recognition performance may be varied according to a touch position. Movement distances D1 and D2 of a user's finger on the curved screen 10B are the same, but lengths L1 and L2 of trajectories detected based on the infrared image are different from each other. As a result, even though the user has an intention to perform the touch drag gesture, the touch display apparatus does not recognize the touch drag gesture when the length L1 of the trajectory is less than the threshold value.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to provide a method and an apparatus for recognizing a touch drag gesture on a curved screen having advantages of precisely determining whether a user has an intention to perform the touch drag gesture based on a gesture start point and a gesture start direction.

A method for recognizing a touch drag gesture on a curved screen according to a first exemplary form of the present disclosure may include: dividing the curved screen into a plurality of areas; setting a plurality of threshold values that correspond to each of gesture start directions in the plurality of areas; detecting a gesture start point based on infrared images received from an infrared camera disposed to face the curved screen; determining an area where the gesture start point exists from among the plurality of areas; determining a gesture start direction in the area where the gesture start point exists; selecting a threshold value that corresponds to the gesture start direction in the area where the gesture start point exists from among the plurality of threshold values; calculating a length of a trajectory from the gesture start point to a gesture end point; and recognizing the touch drag gesture based on the trajectory when the length of the trajectory is greater than the selected threshold value.

The plurality of threshold values may be set based on curvature values of the curved screen and a positional relationship between the curved screen and the infrared camera.

The method may further include recognizing the trajectory as noise when the length of the trajectory is less than or equal to the selected threshold value.

The method may further include: setting a plurality of illumination intensities that correspond to each of the gesture start directions in the plurality of areas; selecting an illumination intensity that corresponds to the gesture start direction in the area where the gesture start point exists from among the plurality of illumination intensities; and controlling an infrared illuminator to illuminate infrared rays with the selected illumination intensity.

The plurality of illumination intensities may be set based on curvature values of the curved screen and a positional relationship between the curved screen and the infrared camera.

A method for recognizing a touch drag gesture on a curved screen according to a second exemplary form of the present disclosure may include: dividing the curved screen into a plurality of areas; setting a plurality of illumination intensities that correspond to each of gesture start directions in the plurality of areas; detecting a gesture start point based on infrared images received from an infrared camera disposed to face the curved screen; determining an area where the gesture start point exists from among the plurality of areas; determining a gesture start direction in the area where the gesture start point exists; selecting an illumination intensity that corresponds to the gesture start direction in the area where the gesture start point exists from among the plurality of illumination intensities; controlling an infrared illuminator to illuminate infrared rays with the selected illumination intensity; calculating a length of a trajectory from the gesture start point to a gesture end point; and recognizing the touch drag gesture based on the trajectory when the length of the trajectory is greater than a predetermined threshold value.

The plurality of illumination intensities may be set based on curvature values of the curved screen and a positional relationship between the curved screen and the infrared camera.

The method may further include recognizing the trajectory as noise when the length of the trajectory is less than or equal to the predetermined threshold value.

An apparatus for recognizing a touch drag gesture on a curved screen according to the first exemplary form may include: an infrared illuminator configured to illuminate infrared rays to the curved screen; an infrared camera configured to capture infrared images of the curved screen; and a controller configured to divide the curved screen into a plurality of areas and set a plurality of threshold values that correspond to each of gesture start directions in the plurality of areas, wherein the controller may detect a gesture start point based on the infrared images, determine an area where the gesture start point exists from among the plurality of areas, determine a gesture start direction in the area where the gesture start point exists, select a threshold value that corresponds to the gesture start direction in the area where the gestures start point exists from among the plurality of threshold values, calculate a length of a trajectory from the gesture start point to a gesture end point, and recognize the touch drag gesture based on the trajectory when the length of the trajectory is greater than the selected threshold value.

The controller may set the plurality of threshold values based on curvature values of the curved screen and a positional relationship between the curved screen and the infrared camera.

The controller may recognize the trajectory as noise when the length of the trajectory is less than or equal to the selected threshold value.

The controller may set a plurality of illumination intensities that correspond to each of the gesture start directions in the plurality of areas, select an illumination intensity that corresponds to the gesture start direction in the area where the gesture start point exists from among the plurality of illumination intensities, and control the infrared illuminator to illuminate infrared rays with the selected illumination intensity.

The controller may set the plurality of illumination intensities based on curvature values of the curved screen and a positional relationship between the curved screen and the infrared camera.

An apparatus for recognizing a touch drag gesture on a curved screen according to the second exemplary embodiment of the present invention may include: an infrared illuminator configured to illuminate infrared rays to the curved screen; an infrared camera configured to capture infrared images of the curved screen; and a controller configured to divide the curved screen into a plurality of areas and set a plurality of threshold values that correspond to each of gesture start directions in the plurality of areas, wherein the controller may detect a gesture start point based on the infrared images, determine an area where the gesture start point exists from among the plurality of areas, determine a gesture start direction in the area where the gesture start point exists, select an illumination intensity that corresponds to the gesture start direction in the area where the gesture start point exists from among the plurality of illumination intensities, calculate a length of a trajectory from the gesture start point to a gesture end point, and recognize the touch drag gesture based on the trajectory when the length of the trajectory is greater than a predetermined threshold value.

The controller may set the plurality of illumination intensities based on curvature values of the curved screen and a positional relationship between the curved screen and the infrared camera.

The controller may recognize the trajectory as noise when the length of the trajectory is less than or equal to the predetermined threshold value.

In exemplary forms of the present disclosure, the touch drag gesture on the curved screen may be precisely recognized by selecting the threshold value or the illumination intensity based on the gesture start point and the gesture start direction.

### BRIEF DESCRIPTION OF THE DRAWINGS

FIG. 1 is a schematic diagram of a curved display apparatus for a vehicle.

FIG. 2 is a drawing showing a curved screen viewed from an interior of a vehicle.

FIG. 3 is a flowchart of a first form of a method for recognizing a touch drag gesture on a curved screen.

FIG. 4 is a drawing for explaining the first form of a method for recognizing a touch drag gesture on a curved screen.

FIG. 5 is a flowchart of a second form of a method for recognizing a touch drag gesture on a curved screen.

FIG. 6 is a drawing for explaining the second form of a method for recognizing a touch drag gesture on a curved screen.

FIG. 7 and FIG. 8 are drawings for explaining a method for recognizing a touch drag gesture according to the related art.

### DETAILED DESCRIPTION

Hereinafter, the present disclosure will be described more fully with reference to the accompanying drawings, in which exemplary forms of the disclosure are shown. However, the present disclosure is not limited to the exemplary forms which are described herein, and may be modified in various different ways.

Parts that are irrelevant to the description will be omitted to clearly describe the present disclosure, and the same or similar elements will be designated by the same reference numerals throughout the specification.

Further, each configuration illustrated in the drawings is arbitrarily shown for better understanding and ease of description, but the present disclosure is not limited thereto.

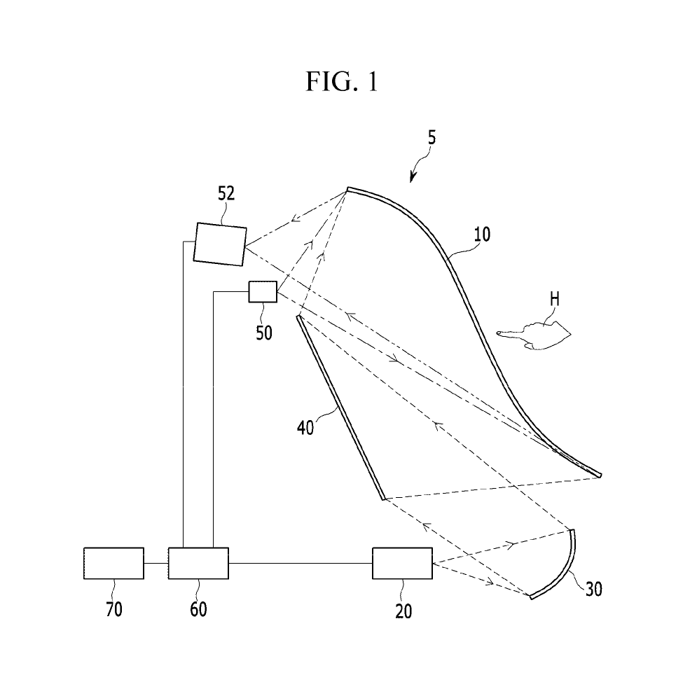

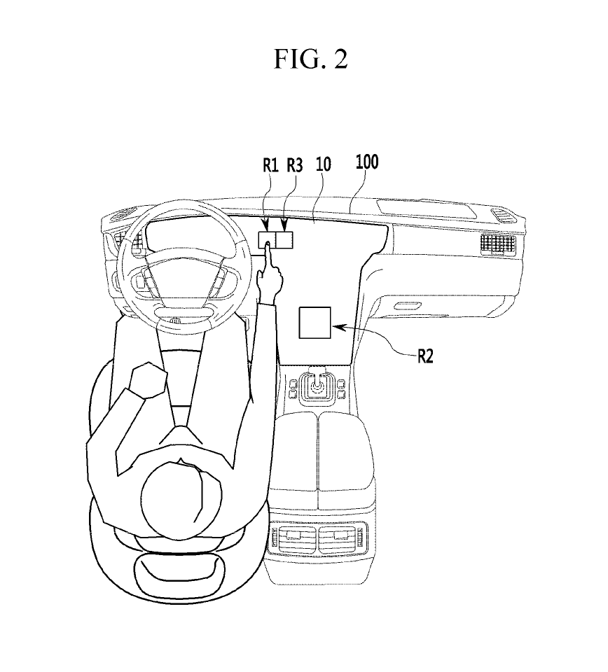

FIG. 1 is a schematic diagram of a curved display apparatus for a vehicle. FIG. 2 is a drawing showing a curved screen viewed from an interior of a vehicle.

As shown in FIG. 1 and FIG. 2, a curved display apparatus 5 for a vehicle may include a curved screen 10, a projector 20, a first mirror 30, a second mirror 40, an infrared illuminator 50, an infrared camera 52, and a controller 60.

The curved display apparatus 5 is provided in a dashboard 100 of the vehicle according to an interior design of the vehicle.

The projector 20 projects an image onto a predetermined area. The image is displayed on the curved screen 10, and may be visually recognized by a user such as a driver. The controller 60 receives external video signals to determine an image to be displayed on the curved screen 10, and controls the projector 20 according to the determined image.

The image may include cluster information, navigation information, audio information, and air conditioning information. In other words, the image may include images displaying operating states of a cluster device, a navigation device, an audio device, and an air conditioner, and selectable (touchable) interface objects. The interface object refers to information that is selected by an input of the user and controlled by an intention of the user. For example, the interface object may be an image, an icon, text, content, and a list.

In order to display the cluster information, the navigation information, the audio information, and the air conditioning information, the curved screen 10 may be formed to have a large area.

The first mirror 30 and the second mirror 40 may be disposed between the curved screen 10 and the projector 20. The image projected from the projector 20 is reflected to the second mirror 40 via the first mirror 30. The image reflected from the second mirror 40 is projected to the curved screen 10 and then displayed to the user.

The first mirror 30 may be an aspherical mirror manufactured depending on curvature values of the screen 10. In addition, by using the first mirror 30, the path depth of light required for displaying the image on the curved screen 10 may be adjusted to reduce size of a space required for mounting the curved display apparatus 5.

The infrared illuminator 50 and the infrared camera 52 are used to recognize a touch of the user. The infrared illuminator 50 and the infrared camera 52 are disposed to face the curved screen 10.

The infrared illuminator 50 illuminates infrared rays to the curved screen 10. The infrared camera 52 captures infrared images that correspond to the entire area of the curved screen 10 and transmits the infrared images to the controller 60. When a user's finger H touches any point on the curved screen 10, the infrared rays are reflected from the user's finger H, the infrared camera 52 captures infrared images, and then the controller 60 detects a touch point based on the infrared images.

An image displayed by the projector 20 is indicated by dotted lines, an infrared illumination area is indicated by one-point chain lines, and a captured area is indicated by two-point chain lines in FIG. 1.

The controller 60 may be implemented with one or more microprocessors executed by a predetermined program, and the predetermined program may include a series of commands for performing each step included in a method for recognizing a touch drag gesture on the curved screen 10 according to an exemplary embodiment of the present invention.

The controller 60 recognizes the touch drag gesture and transmits a controls signal corresponding thereto to an electronic device 70 (e.g., the cluster device, the navigation device, the audio device, and the air conditioner) mounted in the vehicle. The electronic device 70 may execute a predetermined function according to the control signal. For example, when a music search function of the audio device is activated, a next music file may be selected according to the touch drag gesture.

Hereinafter, a method for recognizing a touch drag gesture on a curved screen according to a first exemplary embodiment of the present invention will be described with reference to FIG. 1 to FIG. 4.

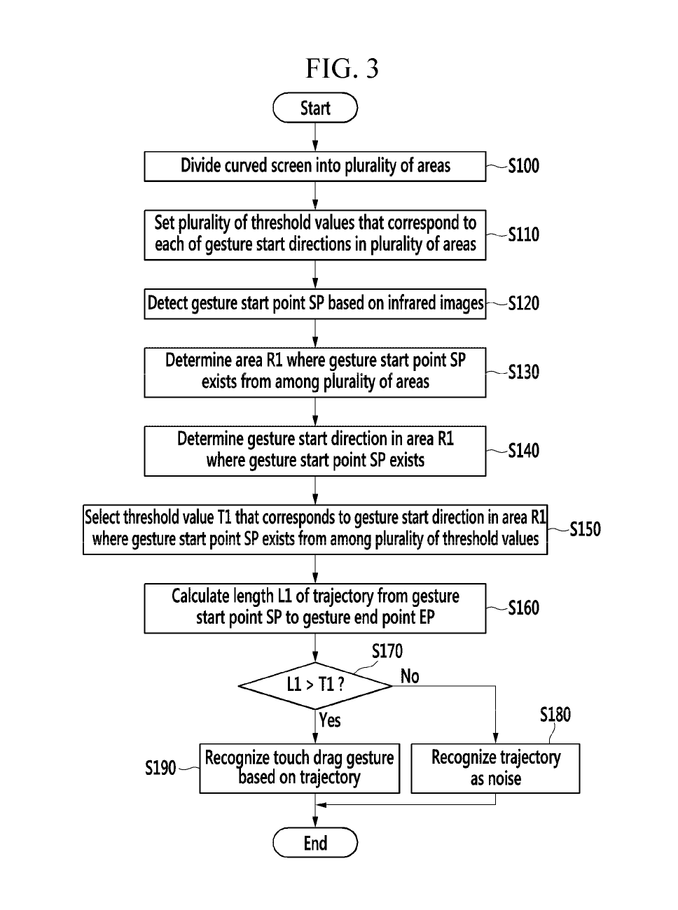

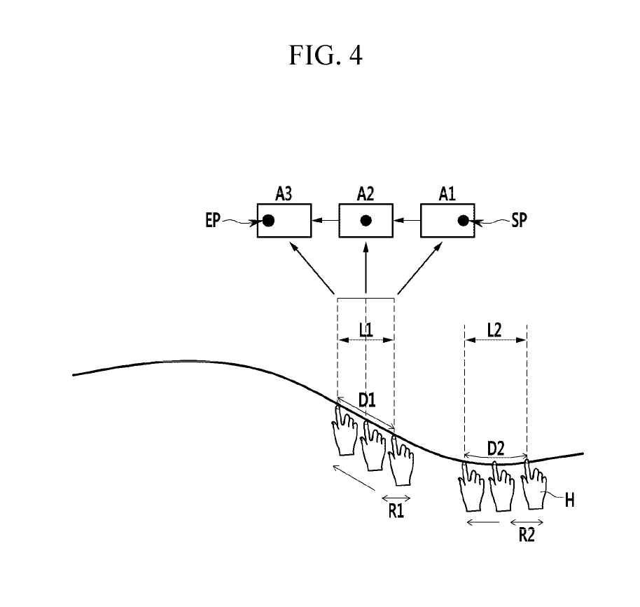

FIG. 3 is a flowchart of a first form of a method for recognizing a touch drag gesture on a curved screen, and FIG. 4 is a drawing for explaining the first form of a method for recognizing a touch drag gesture on a curved screen.

Referring to FIG. 1 to FIG. 4, the first form of a method for recognizing the touch drag gesture on the curved screen 10 begins with dividing the curved screen 10 into a plurality of areas at step S100. A first area R1 and a second area R2 having different sizes are exemplified in FIG. 2 and FIG. 4, but the present disclosure is not limited thereto. The controller 60 may divide the curved screen 10 into the plurality of areas in consideration of the size and the curvature values of the curved screen 10. For example, compared to a portion with a nearly planar surface, a portion with a large step of the curved screen 10 may be subdivided.

The touch drag gesture may be realized when the user's finger H moves on the curved screen 10. Hereinafter, the case where the user initially touches the first area R1 will be mainly described.

The controller 60 sets a plurality of threshold values that correspond to each of gesture start directions in the plurality of areas at step S110. The threshold value refers to a reference value for determining that the user has an intention to perform the touch drag gesture. The plurality of threshold values may be set based on the curvature values of the curved screen 10 and a positional relationship between the curved screen 10 and the infrared camera 52. The gesture start direction refers to a direction in which the user's finger contacting the curved screen 10 moves from one point to another point. For example, the controller 60 may set a threshold value T1 that corresponds to a left direction in the first area R1 and a second value T2 that corresponds to a left direction in the second area R2. In this case, the threshold value T1 that corresponds to the left direction in the first area R1 may be less than the threshold value T2 that corresponds to the left direction in the second area R2.

The controller 60 detects a start point SP based on infrared images received from the infrared camera 52 at step S120.

The controller 60 determines an area where the gesture start point SP exists from among the plurality of areas at step S130. In other words, the controller 60 determines the first area R1 where the gesture start point SP exists.

The controller 60 determines a gesture start direction in the first area R1 where the gesture start point SP exists at step S140. For example, the controller 60 determines that the user's finger moves in the left direction based on infrared images A1 and A2.

The controller 60 selects a threshold value that corresponds to the gesture start direction in the first area R1 where the gesture start point SP exists from among the plurality of threshold values at step S150. In other words, the controller 60 selects the threshold value T1 that corresponds to the gesture start direction in the area R1 where the gesture start point SP exists from among threshold values including the threshold values T1 and T2.

The controller 60 calculates a length L1 of a trajectory from the gesture start point SP to a gesture end point EP at step S160. The controller 60 detects the gesture end point EP based on the infrared images.

The controller 60 compares the length L1 of the trajectory with the selected threshold value T1 at step S170.

When the length L1 is less than or equal to the selected threshold value T1 at step S170, the controller 60 recognizes the trajectory as noise at step S180. In other words, the controller 60 determines that the user does not have an intention to perform the touch drag gesture, and does not recognize the touch drag gesture.

When the length L1 is greater than the selected threshold value T1 at step S170, the controller 60 recognizes the touch drag gesture based on the trajectory at step S190. The controller 60 may transmit a control signal that corresponds to the recognized touch drag gesture to the electronic device 70, and the electronic device 70 may perform a predetermined function according to the control signal.

In the first form of the present disclosure, gesture recognition performance is not varied according to a touch point and a drag direction.

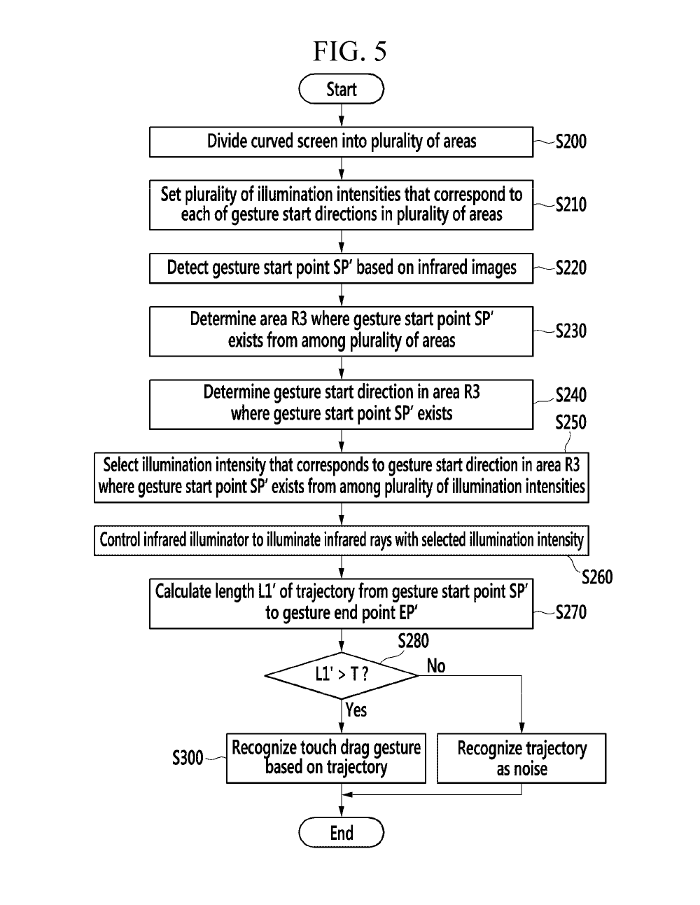

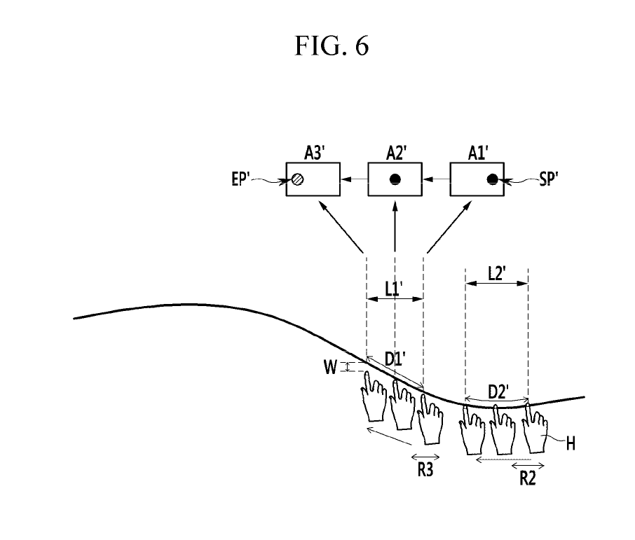

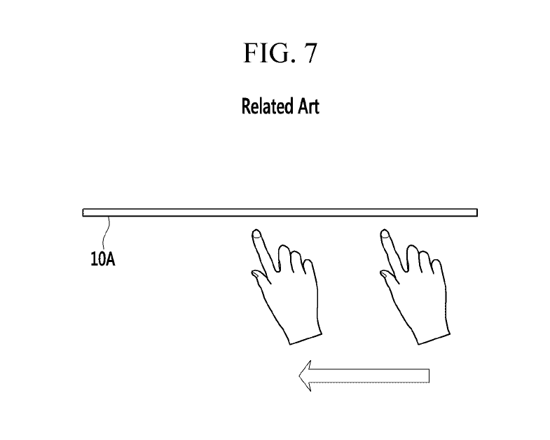

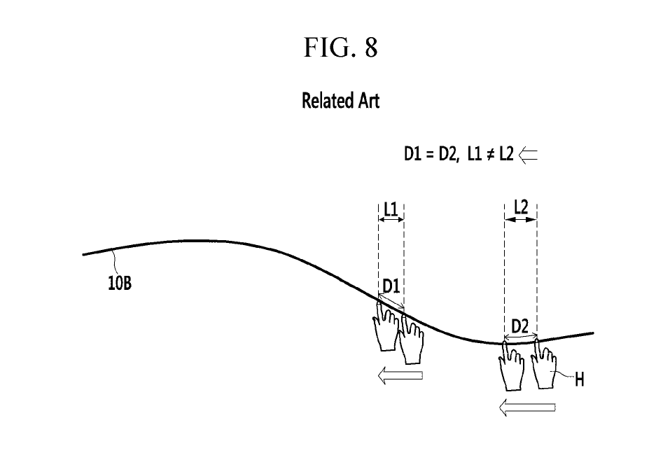

Hereinafter, a second form of a method for recognizing a touch drag gesture on a curved screen will be described with reference to FIG. 1, FIG. 2, FIG. 5, and FIG. 6. A description which is the same as that the first form that has been described above will be omitted.

FIG. 5 is a flowchart of a second form of a method for recognizing a touch drag gesture on a curved screen, and FIG. 6 is a drawing for explaining the second form of a method for recognizing a touch drag gesture on a curved screen.

Referring to FIG. 1, FIG. 2, FIG. 5, and FIG. 6, the second form of the method for recognizing the touch drag gesture on the curved screen 10 begins with dividing the curved screen 10 into a plurality of areas at step S200. The controller 60 may divide the curved screen 10 into the plurality of areas in consideration of the size and the curvature values of the curved screen 10.

Hereinafter, the case where the user initially touches a third area R3 will be mainly described.

The controller 60 sets a plurality of illumination intensities that correspond to each of gesture start directions in the plurality of areas at step S210. Even though a user's finger H is spaced apart from the curved screen 10 by a predetermined distance W, the controller 60 may determine that the user's finger H touches the curved screen 10 when the illumination intensity of the infrared illuminator 50 is high. The plurality of illumination intensities may be set based on the curvature values of the curved screen 10 and a positional relationship between the curved screen 10 and the infrared camera 52. In this case, the illumination intensity that corresponds to the left direction in the third area R3 may be greater than the illumination intensity that corresponds to the left direction in the second area R2.

In a state in which the infrared illuminator 50 illuminates infrared rays with a basic (default) illumination intensity, the controller 60 detects a gesture start point SP′ based on infrared images received from the infrared camera 52 at step S220.

The controller 60 determines an area where the gesture start point SP′ exists from among the plurality of areas at step S230. In other words, the controller 60 determines the third area R3 where the gesture start point SP′ exists.

The controller 60 determines a gesture start direction in the third area R3 where the gesture start point SP′ exists at step S240. For example, the controller 60 determines that the user's finger moves in the left direction based on infrared images A1′ and A2′.

The controller 60 selects the illumination intensity that corresponds to the gesture start direction in the third area R3 where the gesture start point SP′ exists from among the plurality of illumination intensities at step S250.

The controller 60 controls the infrared illuminator 50 to illuminate infrared rays with the selected illumination intensity at step S260. Accordingly, even though the user's finger H is spaced apart from the curved screen 10 by a predetermined distance W, the controller 60 may determine that the user's finger H touches the curved screen 10.

The controller 60 calculates a length L1′ of a trajectory from the gesture start point SP′ to a gesture end point EP′ at step S270. The controller 60 detects the gesture end point EP′ based on the infrared images.

The controller 60 compares the length L1′ of the trajectory with a predetermined threshold value T at step S280.

When the length L1′ is less than or equal to the predetermined threshold value T at step S280, the controller 60 recognizes the trajectory as noise at step S290. In other words, the controller 60 determines that the user does not have an intention to perform the touch drag gesture, and does not recognize the touch drag gesture.

When the length L1′ is greater than the predetermined threshold value T at step S280, the controller 60 recognizes the touch drag gesture based on the trajectory at step S300. The controller 60 may transmit a control signal that corresponds to the recognized touch drag gesture to the electronic device 70, and the electronic device 70 may perform a predetermined function according to the control signal.

In the second form of the present disclosure, even though the predetermined threshold value T is fixed, gesture recognition performance is not varied according to a touch point and a drag direction.

Although the specification illustrates that the controller 60 separately sets the plurality of threshold values and the plurality of illumination intensities, the present invention is not limited thereto. That is, the controller 60 may select both the threshold value and the illumination intensity based on the gesture start direction in the area where the gesture start point exists.

The controller 60 may set the plurality of illumination intensities that correspond to each of gesture start directions in the plurality of areas at step S110.

The controller 60 may select the illumination intensity that corresponds to the gesture start direction in the first area R1 where the gesture start point SP exists from among the plurality of illumination intensities at step S150. In this case, the controller 60 may control the infrared illuminator 50 to illuminate infrared rays with the selected illumination intensity.

In the exemplary forms of the present disclosure, the touch drag gesture on the curved screen 10 may be precisely recognized by selecting the threshold value or the illumination intensity based on the gesture start point and the gesture start direction.

While this disclosure has been described in connection with what is presently considered to be practical exemplary forms, it is to be understood that the disclosure is not limited to the disclosed forms, but, on the contrary, is intended to cover various modifications and equivalent arrangements included within the spirit and scope of the appended claims.

What is claimed is:

1. A method for recognizing a touch drag gesture on a curved screen, comprising:
dividing the curved screen into a plurality of areas;
setting a plurality of threshold values, where each threshold value corresponds to a gesture start direction in the plurality of areas;
detecting a gesture start point based on infrared images received from an infrared camera disposed to face the curved screen;
determining an area where the gesture start point exists from among the plurality of areas;
determining a gesture start direction in the area where the gesture start point exists;
selecting a threshold value that corresponds to the gesture start direction in the area where the gesture start point exists from among the plurality of threshold values;
calculating a length of a trajectory from the gesture start point to a gesture end point; and
recognizing the touch drag gesture based on the trajectory when the length of the trajectory is greater than the selected threshold value.

2. The method of claim 1, wherein the plurality of threshold values is set based on curvature values of the curved screen and a positional relationship between the curved screen and the infrared camera.

3. The method of claim 1, further comprising:
recognizing the trajectory as noise when the length of the trajectory is less than or equal to the selected threshold value.

4. The method of claim 1, further comprising:
setting a plurality of illumination intensities that correspond to each of the gesture start directions in the plurality of areas;
selecting an illumination intensity that corresponds to the gesture start direction in the area where the gesture start point exists from among the plurality of illumination intensities; and
controlling an infrared illuminator to illuminate infrared rays with the selected illumination intensity.

5. The method of claim 4, wherein the plurality of illumination intensities is set based on curvature values of the curved screen and a positional relationship between the curved screen and the infrared camera.

6. A method for recognizing a touch drag gesture on a curved screen, comprising:
dividing the curved screen into a plurality of areas;
setting a plurality of illumination intensities, where each illumination intensity corresponds to a gesture start direction in the plurality of areas;
detecting a gesture start point based on infrared images received from an infrared camera disposed to face the curved screen;
determining an area where the gesture start point exists from among the plurality of areas;
determining a gesture start direction in the area where the gesture start point exists;
selecting an illumination intensity that corresponds to the gesture start direction in the area where the gesture start point exists from among the plurality of illumination intensities;
controlling an infrared illuminator to illuminate infrared rays with the selected illumination intensity;
calculating a length of a trajectory from the gesture start point to a gesture end point; and
recognizing the touch drag gesture based on the trajectory when the length of the trajectory is greater than a predetermined threshold value.

7. The method of claim 6, wherein the plurality of illumination intensities is set based on curvature values of the curved screen and a positional relationship between the curved screen and the infrared camera.

8. The method of claim 6, further comprising:
recognizing the trajectory as noise when the length of the trajectory is less than or equal to the predetermined threshold value.

9. An apparatus for recognizing a touch drag gesture on a curved screen, comprising:
an infrared illuminator configured to illuminate infrared rays to the curved screen;
an infrared camera configured to capture infrared images of the curved screen; and
a controller configured to divide the curved screen into a plurality of areas and to set a plurality of threshold values, where each threshold value corresponds to a gesture start direction in the plurality of areas,
wherein the controller is further configured to detect a gesture start point based on the infrared images, determine an area where the gesture start point exists from among the plurality of areas, determine a gesture start direction in the area where the gesture start point exists, select a threshold value that corresponds to the gesture start direction in the area where the gestures start point exists from among the plurality of threshold values, calculate a length of a trajectory from the gesture start point to a gesture end point, and recognize the touch drag gesture based on the trajectory when the length of the trajectory is greater than the selected threshold value.

10. The apparatus of claim 9, wherein the controller is configured to set the plurality of threshold values based on curvature values of the curved screen and a positional relationship between the curved screen and the infrared camera.

11. The apparatus of claim 9, wherein the controller is configured to recognize the trajectory as noise when the length of the trajectory is less than or equal to the selected threshold value.

12. The apparatus of claim 9, wherein the controller is further configured to:
set a plurality of illumination intensities, where each illumination intensity corresponds to a gesture start direction in the plurality of areas,
select an illumination intensity that corresponds to the gesture start direction in the area where the gesture start point exists from among the plurality of illumination intensities, and
control the infrared illuminator to illuminate infrared rays with the selected illumination intensity.

13. The apparatus of claim 12, wherein the controller is configured to set the plurality of illumination intensities based on curvature values of the curved screen and a positional relationship between the curved screen and the infrared camera.

14. An apparatus for recognizing a touch drag gesture on a curved screen, comprising:
an infrared illuminator configured to illuminate infrared rays on the curved screen;
an infrared camera configured to capture infrared images of the curved screen; and
a controller configured to divide the curved screen into a plurality of areas and to set a plurality of threshold values, where each threshold value corresponds to a gesture start direction in the plurality of areas,
wherein the controller is further configured to detect a gesture start point based on the infrared images, determine an area where the gesture start point exists from among the plurality of areas, determine a gesture start direction in the area where the gesture start point exists, select an illumination intensity that corresponds to the gesture start direction in the area where the gesture start point exists from among the plurality of illumination intensities, calculate a length of a trajectory from the gesture start point to a gesture end point, and recognize the touch drag gesture based on the trajectory when the length of the trajectory is greater than a predetermined threshold value.

15. The apparatus of claim 14, wherein the controller is further configured to set the plurality of illumination intensities based on curvature values of the curved screen and a positional relationship between the curved screen and the infrared camera.

16. The apparatus of claim 14, wherein the controller is further configured to recognize the trajectory as noise when the length of the trajectory is less than or equal to the predetermined threshold value.
